(19) United States
(12) Patent Application Publication
(10) Pub. No.: US 2017/0080632 A1
(43) Pub. Date: Mar. 23, 2017

(54) APPARATUS AND METHOD FOR MOLDING WINDOW

(71) Applicant: SAMSUNG DISPLAY CO., LTD., Yongin-si (KR)

(72) Inventors: Hyunseung Seo, Anyang-si (KR); Sukman Yang, Seoul (KR); Youngsik Yoon, Seoul (KR); Jonghwan Cho, Ansan-si (KR)

(21) Appl. No.: 15/178,497

(22) Filed: Jun. 9, 2016

(30) Foreign Application Priority Data
Sep. 22, 2015 (KR) 10-2015-0134061

(51) Int. Cl. B29C 53/84; B29C 47/00; B29C 53/04

(52) U.S. Cl. CPC B29C 53/84; B29C 53/04; B29C 47/0019; B29C 47/0059; B29L 2031/3475

(57) ABSTRACT

Provided is an apparatus for molding a window, the apparatus including a mold in which a base window including a window bending part and a window flatness part is located and a cooling device configured to cool the base window. The window bending part includes a first bending surface and a second bending surface, which face each other. The cooling device includes a first cooling part configured to cool the first bending surface by using a cooling source having a first temperature, a second cooling part configured to cool the second bending surface by using a cooling source having a second temperature, and a third cooling part configured to cool the window flatness part. The first bending surface has an area greater than that of the second bending surface, and the first temperature is less than the second temperature.

### CROSS-REFERENCE TO RELATED APPLICATIONS

This application claims priority to the benefit of Korean Patent Application No. 10-2015-0134061, filed on Sep. 22, 2015, the entire content of which is hereby incorporated herein by reference.

### BACKGROUND

The present disclosure herein relates to an apparatus and method for molding a window.

Recently, with the development of multimedia, various display devices such as liquid crystal displays (LCDs) and organic light emitting devices (OLEDs) are being commercialized.

Such display devices typically have a screen that is exposed to the outside to provide visual information such as an image or video to a user. Since the screen is vulnerable to external impacts and scratches, a window cover for protecting the screen of the display device may be attached to the display device.

Recently, as curved display devices are developing, demands of a window including a curved surface are being increased.

### SUMMARY

The present disclosure provides an apparatus for molding a window. In detail, embodiments of the present invention provide an apparatus for molding a window, which includes a cooling device capable of minimizing warpage of a bending part.

The present disclosure also provides a method for molding a window. In detail, the embodiments of the present invention provide a method for molding a window, which includes a cooling process for minimizing warpage of a bending part.

An embodiment of the present disclosure provides apparatuses for molding a window, the apparatuses including: a mold in which a base window including a window bending part and a window flatness part is located; and a cooling device configured to cool the base window, wherein the window bending part includes a first bending surface and a second bending surface, which face each other, and the cooling device includes: a first cooling part configured to cool the first bending surface by using a cooling source having a first temperature; a second cooling part configured to cool the second bending surface by using a cooling source having a second temperature; and a third cooling part configured to cool the window flatness part, wherein the first bending surface has an area greater than that of the second bending surface, and the first temperature is less than the second temperature.

In an embodiment, the first bending surface may have a first curvature radius, and the second bending surface may have a second curvature radius less than the first curvature radius.

In an embodiment, the third cooling part may cool the window flatness part by using a cooling source having a third temperature, and the third temperature may be greater than the first temperature and less than the second temperature.

In an embodiment, the mold may include: an upper mold including an upper bending part contacting the first bending surface and an upper flat part contacting the window flatness part; and a lower mold including a lower bending part contacting the second bending surface and a lower flat part contacting the window flatness part.

In an embodiment, the first bending surface may include: a first sub bending surface connected to one end of the window flatness part; and a second sub bending surface connected to the other end of the window flatness part, wherein the first cooling part may include: a first sub cooling part configured to cool the first sub bending surface; and a second sub cooling part configured to cool the second sub bending surface, wherein the second bending surface may include: a third sub bending surface connected to one end of the window flatness part; and a fourth sub bending surface connected to the other end of the window flatness part, wherein the second cooling part may include: a third sub cooling part configured to cool the third sub bending surface; and a fourth sub cooling part configured to cool the fourth sub bending surface.

In an embodiment, the window flatness part may include a first flat surface and a second flat surface, which face each other, and the third cooling part may include: a fifth sub cooling part configured to cool the first flat surface; and a sixth sub cooling part configured to cool the second flat surface.

In an embodiment, the first cooling part may be located in the upper bending part of the upper mold, the second cooling part may be located in the lower bending part of the lower mold, and the third cooling part may be located in at least one of the upper flat part of the upper mold and the lower flat part of the lower mold.

In an embodiment, the upper bending part may include an upper bending surface contacting the first bending surface, the lower bending part may include a lower bending surface contacting the second bending surface, and the upper bending surface may have an area greater than that of the lower bending surface.

In an embodiment, the upper bending surface may have a third curvature radius, and the lower bending surface may have a fourth curvature radius less than the third curvature radius.

In an embodiment, based on a central line, the upper bending surface may be divided into a first sub upper bending surface including one end connected to the upper flat part and a second sub upper bending surface including the other end spaced from the upper flat part, and at least a portion of the second sub upper bending surface may overlap at least a portion of the first sub upper bending surface on a plane.

In an embodiment, based on a central line, the lower bending surface may be divided into a first sub lower bending surface including one end connected to the lower flat part and a second sub lower bending surface including the other end spaced from the lower flat part, and at least a portion of the second sub lower bending surface may overlap at least a portion of the first sub lower bending surface on a plane.

In an embodiment, the apparatuses may further include: a first partition wall located between the upper bending part and the upper flat part; and a second partition wall located between the lower bending part and the lower flat part, wherein the first partition wall has thermal conductivity less than that of the upper mold, and the second partition wall may have thermal conductivity less than that of the lower mold.

In an embodiment, the upper mold and the lower mold may be spaced from each other, and a space between the upper mold and the lower mold may be divided into a base window seating region and a peripheral region connected to the base window seating region.

In an embodiment, the apparatuses may further include a third partition wall located in the peripheral region, wherein the third partition wall may have thermal conductivity less than that of each of the upper mold and the lower mold.

In an embodiment, the apparatuses may further include a provision part configured to provide the base window, wherein the provision part may include: an extruder configured to receive and extrude a material for the base window; and a die configured to receive the extruded the material, thereby discharging the received material to the base window including the window flatness part and the window bending part.

An embodiment of the present disclosure provides a method for molding a window, the method including: providing a base window including a window bending part and a window flatness part to a cooling device; and cooling the base window, wherein the window bending part includes a first bending surface and a second bending surface, which face each other, and the cooling of the base window includes: cooling the first bending surface using a cooling source having a first temperature; cooling the second bending surface using a cooling source having a second temperature; and cooling the window flatness part, wherein the first bending surface has an area greater than that of the second bending surface, and the first temperature is less than the second temperature.

In an embodiment, the cooling of the window flatness part may be cooling the window flatness part using a cooling source having a third temperature, and the first temperature, the second temperature, and the third temperature satisfy a following Equation 1:

First temperature<Third temperature<Second temperature [Equation 1]

In an embodiment, the providing of the base window to the cooling device may include providing the base window to the cooling device including an upper mold and a lower mold, wherein the upper mold may include an upper bending part contacting the first bending surface and an upper flat part contacting the window flatness part, and a lower mold may include a lower bending part contacting the second bending surface and a lower flat part contacting the window flatness part.

In an embodiment, based on a central line, the first bending surface may be divided into a first sub bending surface including one end connected to the window flatness part and a second sub bending surface including the other end spaced from window flatness part, at least a portion of the second sub bending surface may overlap at least a portion of the first sub bending surface on a plane, based on a central line, the second bending surface may be divided into a third sub bending surface including one end connected to the window flatness part and a fourth sub bending surface including the other end spaced from the window flatness part, and at least a portion of the fourth sub bending surface may overlap at least a portion of the third sub bending surface on a plane.

In an embodiment, before the providing of the base window to the cooling device, the method may further include: extruding a material for the base window; and molding the extruded material to mold the base window including the window flatness part and the window bending part.

### BRIEF DESCRIPTION OF THE FIGURES

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIG. 1 is a schematic view of an apparatus for molding a window according to an embodiment of the present disclosure;

FIG. 2 is a schematic cross-sectional view of a mold provided in the apparatus for molding the window according to an embodiment of the present disclosure;

FIG. 3A is a schematic cross-sectional view of a base window that is an object to be cooled in a cooling device provided in the apparatus for molding the window according to an embodiment of the present disclosure;

FIG. 3B is a schematic perspective view of the base window of FIG. 3A;

FIG. 3C is another schematic perspective view of the base window of FIG. 3A;

FIG. 4 is a schematic cross-sectional view of the mold provided in the apparatus for molding the window according to an embodiment of the present disclosure;

FIG. 5 is a schematic perspective view illustrating a portion of an upper mold of the mold provided in the apparatus for molding the window according to an embodiment of the present disclosure;

FIG. 6 is a schematic perspective view illustrating a portion of a lower mold of the mold provided in the apparatus for molding the window according to an embodiment of the present disclosure;

FIG. 7 is a schematic perspective view of the base window that is the object to be cooled in the cooling device provided in the apparatus for molding the window according to an embodiment of the present disclosure;

FIG. 8 is a schematic cross-sectional view of the mold provided in the apparatus for molding the window according to an embodiment of the present disclosure;

FIG. 9 is a schematic cross-sectional view of the mold provided in the apparatus for molding the window according to an embodiment of the present disclosure;

FIG. 10 is a schematic cross-sectional view of the mold provided in the apparatus for molding the window according to an embodiment of the present disclosure;

FIG. 11 is a schematic flowchart of a process for molding a window according to an embodiment of the present disclosure;

FIG. 12A is a schematic perspective view of a base window molded through the process for molding the window according to an embodiment of the present disclosure;

FIG. 12B is another schematic perspective view of the base window of FIG. 12A; and

FIG. 13 is a schematic perspective view of the base window molded through the process for molding the window according to an embodiment of the present disclosure.

### DETAILED DESCRIPTION

The objects, other objectives, features, and advantages of the present disclosure will be understood without difficulties through preferred embodiments below related to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

Like reference numerals refer to like elements throughout. In the drawings, the dimensions and size of each structure are exaggerated, omitted, or schematically illustrated for convenience in description and clarity. It will be understood that although the terms of first and second are used herein to describe various elements, these elements should not be limited by these terms. The terms are only used to distinguish one component from other components. For example, a first element referred to as a first element in one embodiment can be referred to as a second element in another embodiment. The terms of a singular form may include plural forms unless referred to the contrary.

The meaning of ‘include’ or ‘comprise’ specifies a property, a region, a fixed number, a step, a process, an element and/or a component but does not exclude other properties, regions, fixed numbers, steps, processes, elements and/or components.

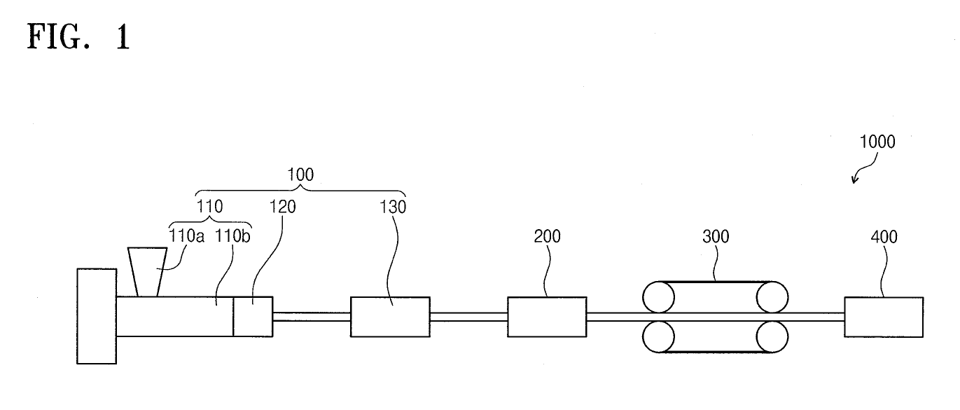

Hereinafter, an apparatus for molding a window according to an embodiment of the present disclosure will be described with reference to FIGS. 1 to 10.

FIG. 1 is a schematic view of an apparatus for molding a window according to an embodiment of the present disclosure.

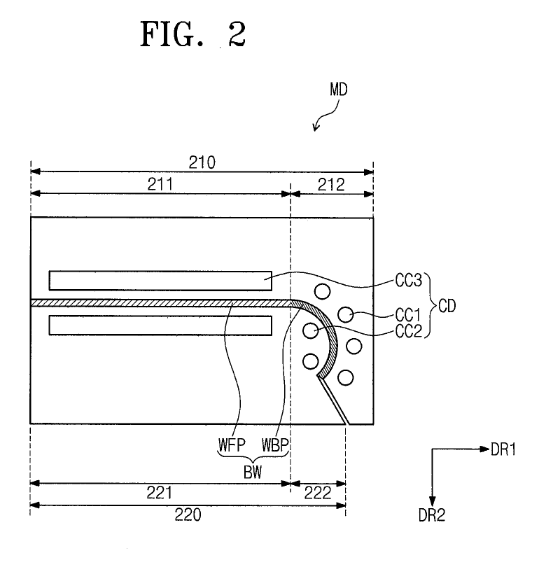

An apparatus 1000 for molding a window according to an embodiment of the invention concept may include a provision part 100 for providing a base window BW (FIG. 2), a cooling part 200 receiving the base window BW from the provision part 100 to cool the base window BW, a pulling part 300 for pulling the base window BW cooled in the cooling part 200, and a cutting part 400 for cutting the pulled base window to a predetermined size.

In this specification, the term “base window” may be an intermediate object after the object is discharged in a predetermined shape from the provision part 100 and before the object is cut to a predetermined size by the cutting part 400, and the term “window” may be a final object that is cut by the cutting part 400.

The provision part 100 may include an extruder 110 receiving a material for the base window BW to extrude the material and a die 120 receiving the extruded material to discharge the window base BW having a predetermined shape. The base window BW may include a window flatness part WFP (FIG. 2) and a window bending part WBP (FIG. 2). Detailed descriptions with respect to the base window BW will be described below.

The extruder 110 may include a hopper 110a into which the material for the base window BW is provided and an extrusion part 110b for extruding the material from the hopper.

The provision part 100 may further include a sizing mold 130 for molding a product with an accurate dimension and planned size while an intermediate object passing through the die 120 is maintained to an outer surface profile thereof.

Although the base window BW is extrusion-molded in FIG. 1, an embodiment of the present disclosure is not limited thereto. For example, as occasion demands, the base window may be injection-molded.

In the case of the extrusion molding, it may be advantageous to manufacture a base window including a bending part having a small curvature radius. In the case of the injection molding, a shape degree of freedom is high.

Hereinafter, the cooling part 200 will be described with reference to FIGS. 2 to 10.

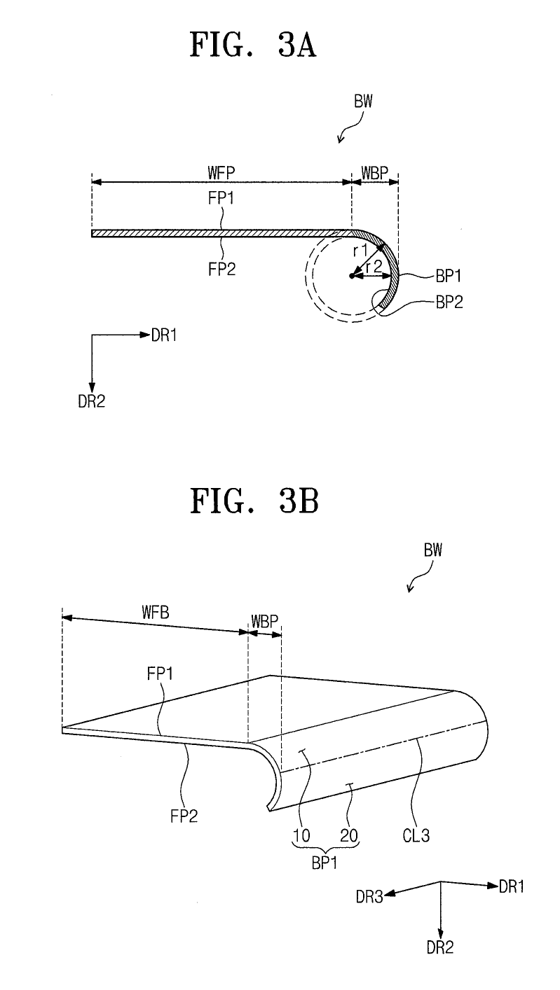

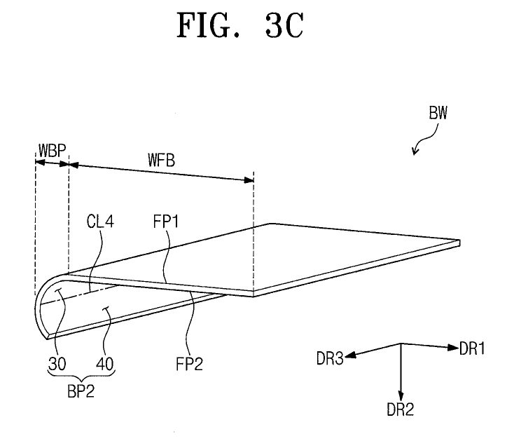

FIG. 2 is a schematic cross-sectional view of a mold provided in the apparatus for molding the window according to an embodiment of the present disclosure. In detail, FIG. 2 is a schematic cross-sectional view of a mold provided in the cooling part of the apparatus for molding the window according to an embodiment of the present disclosure. FIG. 3A is a schematic cross-sectional view of the window located on the mold. FIGS. 3B and 3C are schematic perspective views of the base window that is an object to be cooled in the cooling device provided in the apparatus for molding the window according to an embodiment of the present disclosure.

Referring to FIGS. 2 and 3A to 3C, the apparatus 1000 for molding the window according to an embodiment of the present disclosure includes a mold MD on which the base window BW is located and a cooling device CD for cooling the base window BW.

The base window BW located on the mold MD includes a window bending part WBP and a window flatness part WFP. The window bending part WBP and the window flatness part WFP may be connected to each other and then be integrated with each other.

The base window BW may be formed of a resin, for example, a thermoplastic resin, or a plastic material. Although not limited thereto, the base window BW may include one selected from the group consisting of polycarbonate, cycloolefin polymer, and polymethylmetaacrylate.

In one embodiment, the base window BW may have a thickness of about 0.3 mm to about 1.0 mm, and more specifically, about 0.4 mm to about 1.0 mm. When the base window BW has a thickness less than that of about 0.3 mm, it may be difficult to secure sufficient impact resistance. When the base window BW has a thickness greater than that of about 1.0 mm, it may be difficult to provide a slim display device.

The window bending part WBP includes a first bending surface BP1 and a second bending surface BP2. The first bending surface BP1 and the second bending surface BP2 face each other being located on opposite sides of the window bending part WBP. The first bending surface BP1 has an area greater than that of the second bending surface BP2. The first bending surface BP1 may have a first curvature radius r1, and a second bending surface may have a second curvature radius r2 that is different from, e.g. is less than the first curvature radius r1. The second bending surface BP2 may be adjacent to a bending shaft of the window bending part WBP than the first bending surface BP1.

The first bending surface BP1 may be divided into a first portion 10 having one end connected to a first flat surface FP1 of the window flatness part WFP and a second portion 20 having the other end spaced from the first flat surface FP1, based on a central line CL3.

In this specification, the term “on the plane” may denote a case in which the apparatus 1000 for molding the window is viewed in a thickness direction DR2.

The second bending surface BP2 may be divided into a first portion 30 having one end connected to a second flat surface FP2 of the window flatness part WFP and a second portion 40 having the other end spaced from the second flat surface FP2, based on a central line CL4. In one embodiment, at least a portion of the second portion 40 may overlap at least a portion of the first portion 30 on a plane.

However, an embodiment of the present disclosure is not limited thereto. For example, the areas of the first and second bending surfaces BP1 and BP2 may vary as occasion demands under a condition in which the first bending surface BP1 has an area greater than an area of the second bending surface BP2. For example, if the first bending surface BP1 has an area greater than the second bending surface BP2, at least a portion of the second portion 20 of the first bending surface BP1 may not overlap at least a portion of the first portion 10 on the plane.

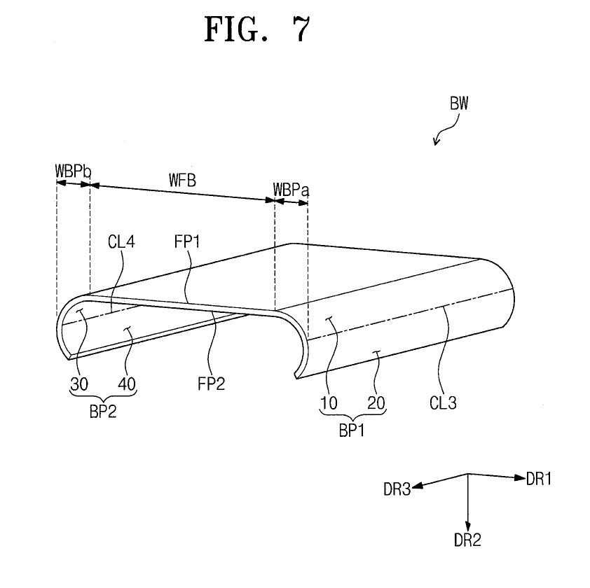

In one embodiment, the window bending part WBP has a large bending angle so that at least a portion of the first portion 10 of the first bending surface BP1 overlaps the second portion 20 on the plane, and at least a portion of the first portion 30 of the second bending surface BP2 overlaps the second portion 40 on the plane. In this case, the base window BW may be extrusion-molded. In the case of injection molding, the mold has to be divided to produce window bending parts WBPa and WBPb, each of which has a large bending angle (FIG. 7). Here, a parting-line may be generated at a portion at which the mold is divided.

The window flatness part WFP includes the first flat surface FP1 and the second flat surface FP2. The first flat surface FP1 and the second flat surface FP2 face each other and are located on opposite sides of the window flatness part WFP. The first flat surface FP1 may be integrally connected to the bending surface BP1. The second flat surface FP2 may be integrally connected to the second bending surface BP2.

The cooling device CD includes a first cooling part CC1, a second cooling part CC2, and a third cooling part CC3. The first cooling part CC1 cools the first bending surface BP1 by using a cooling source having a first temperature, and the second cooling part CC2 cools the second bending surface BP2 by using a cooling source having a second temperature. The third cooling part CC3 cools the window flatness part WFP. In one embodiment, the first temperature is less than the second temperature.

For example, a cooling source having a fixed temperature may be supplied to the cooling device CD. Thus, the cooling device CD may be cooled, and then, the cooled temperature of the cooling device CD may be transferred to the base window BW that is the object to be cooled. As a result, the base window BW may be cooled by the cooling device CD. In other words, the base window BW may be cooled through a method in which the cooling device CD is cooled.

Cooled coolant having a low temperature may be used as the cooling source supplied to the cooling device CD, but is not limited thereto. The cooling source supplied to the cooling device CD may be a refrigerant.

For example, coolant cooled to preset temperatures may be circulated into the first, second, and third cooling parts CC1, CC2, and CC3 to maintain the first, second, and third cooling parts CC1, CC2, and CC3 at desired temperatures, respectively. The coolant may be cooled by an external cooling device. A plurality of valves for injecting and discharging the coolant may be provided in the first, second, and third cooling parts CC1, CC2, and CC3, respectively.

When the cooling parts are cooled at the same temperature and rate, thermal shrinkage rates due to the temperature reduction may be the same. Thus, if the first cooling part CC1 for cooling the first bending surface BP1 and the second cooling part CC2 for cooling the second bending surface BP2 use the cooling source having the same temperature, since the first bending surface BP1 has an area greater than the second bending surface BP2 and thus has a shrinkage volume greater than the second bending surface BP2, warpage in a direction of the first bending surface BP1 may occur. The apparatus 1000 for molding the window according to an embodiment of the present disclosure may control the contraction in volume of the first bending surface BP1 having a relatively wide area due to the reduction in temperature of the first bending surface BP1 by using a cooling source having a temperature less than the second cooling part CC2 in the first cooling part CC1 to minimize the warpage. In detail, the apparatus 1000 for molding the window according to an embodiment of the present disclosure may match the thermal shrinkage rates of the first and second bending surfaces BP1 and BP2 by using a principle in which the thermal shrinkage rates are reduced in the case of quick cooling, e.g., by using a cooling source having a temperature less than that of the second bending surface BP2 having a relatively narrow area in the first bending surface BP1 having the relatively wide area to suppress the occurrence of the warpage.

The third cooling part CC3 may cool the window flatness part WFP by using a cooling source having a temperature different from each of the first and second cooling parts CC1 and CC2. The third cooling part CC3 may cool the window flatness part WFP by using a cooling source having a third temperature. In one embodiment, the third temperature may be greater than the first temperature and less than the second temperature. However, an embodiment of the present disclosure is not limited thereto.

For example, the first temperature may be about 20° C. to about 30° C., the second temperature may be about 50° C. to about 60° C., and the third temperature may be about 35° C. to about 45° C. However, an embodiment of the present disclosure is not limited thereto. For example, if the first temperature is maintained to a temperature less than the second temperature, the specific temperature range may be changed as occasion demands.

The mold MD may include an upper mold 210 and a lower mold 220. The base window BW is located between the upper and lower molds 210 and 220 of the mold MD.

The upper mold 210 includes an upper bending part 212 contacting the first bending surface BP1 of the window bending part WBP and an upper flat part 211 contacting the window flatness part WFP. In detail, the upper mold 210 includes an upper bending part 212 contacting the first bending surface BP1 of the window bending part WBP and an upper flat part 211 contacting the first flat surface FP1 of the window flatness part WFP.

The lower mold 220 includes a lower bending part 222 contacting the second bending surface BP2 of the window bending part WBP and a lower flat part 211 contacting the window flatness part WFP. In detail, the lower mold 220 includes a lower bending part 222 contacting the second bending surface BP2 of the window bending part WBP and a lower flat part 221 contacting the second flat surface FP2 of the window flatness part WFP.

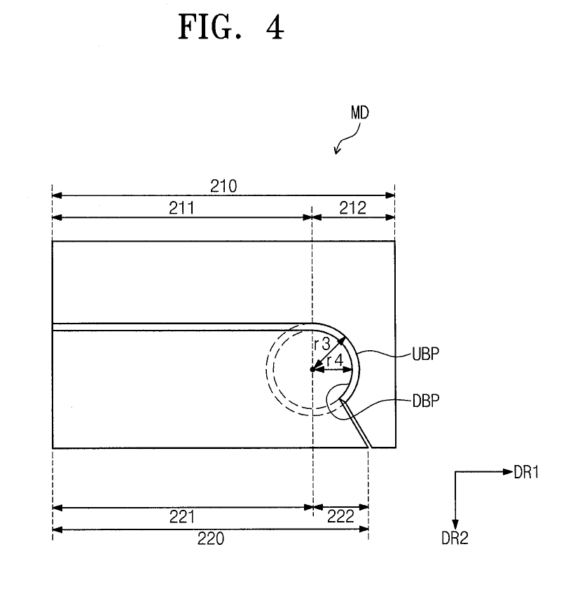

FIG. 4 is a schematic cross-sectional view of the mold provided in the apparatus for molding the window according to an embodiment of the present disclosure.

Referring to FIG. 4, the upper bending part 211 includes an upper bending surface UBP, and the lower bending part 222 includes a lower bending surface DBP. The upper bending surface UBP and the lower bending surface DBP face each other. In detail, the first bending surface BP1 of the base window BW that is an object to be cooled may contact the upper bending surface UBP of the upper mold 210, and the second bending surface BP2 of the base window BW may contact the lower bending surface DBP of the lower mold 220. The first flat surface FP1 of the base window may contact the upper flat part 211 of the upper mold 210, and the second flat surface FP2 of the base window BW may contact the lower flat part 221 of the lower mold 220.

The upper bending surface UBP has a third curvature radius r3, and the lower bending surface DBP has a fourth curvature radius r4. The fourth curvature radius r4 is less than the third curvature radius r3. The lower bending surface DBP may be closer to the bending shaft than the upper bending surface UBP.

Referring to FIGS. 2 to 4, the upper bending surface UBP may contact the entire first bending surface BP1 of the base window BW. The lower bending surface DBP may contact the entire second bending surface BP2 of the base window BW. The entire first flat surface FP1 may contact the upper flat part 211, and the entire second flat surface FP2 may contact the lower flat part 221.

The upper bending surface UBP contacting the first bending surface BP1 of the base window BW may have an area greater than the lower bending surface DBP contacting the second bending surface BP2 of the base window BW.

The cooling device CD may be located in the upper and lower molds 210 and 220. Each of the upper and lower molds 210 and 220 may be formed of a material having high thermal conductivity so that the upper and lower molds 210 and 220 are cooled by the cooling device CD to efficiently cool the base window BW that is the object to be cooled. Each of the upper and lower molds 210 and 220 may be formed of a material such as brass or copper, but is not limited thereto.

As described above, since the base window BW contacts each of the upper and lower molds 210 and 220, when the upper and lower molds 210 and 220 are cooled by the cooling source supplied into the cooling device CD located in the upper and lower molds 210 and 220, the cooling temperature may be transferred to the base window BW to cool the base window BW that is the object to be cooled.

The first cooling part CC1 may be located in the upper bending part 221 of the upper mold 210. Although the first cooling part CC1 has a circular cross-section in FIG. 2, an embodiment of the present disclosure is not limited thereto. Also, although the first cooling part CC1 is provided in plurality in FIG. 2, an embodiment of the present disclosure is not limited thereto. For example, only one integrated first cooling part CC1 may be provided.

The second cooling part CC2 may be located in the lower bending part 222 of the lower mold 220. Although the second cooling part CC2 has a circular cross-section in FIG. 2, an embodiment of the present disclosure is not limited thereto. Also, although the second cooling part CC2 is provided in plurality in FIG. 2, an embodiment of the present disclosure is not limited thereto. For example, only one integrated second cooling part CC2 may be provided.

The third cooling part CC3 may be located in at least one of the upper flat part 211 of the upper mold 210 and the lower flat part 221 of the lower mold 220. To uniformly cool the window flatness part WFP of the base window BW, as illustrated in FIG. 2, the third cooling part CC3 may be located in each of the upper flat part 211 of the upper mold 210 and the lower flat part 221 of the lower mold 220, but is not limited thereto.

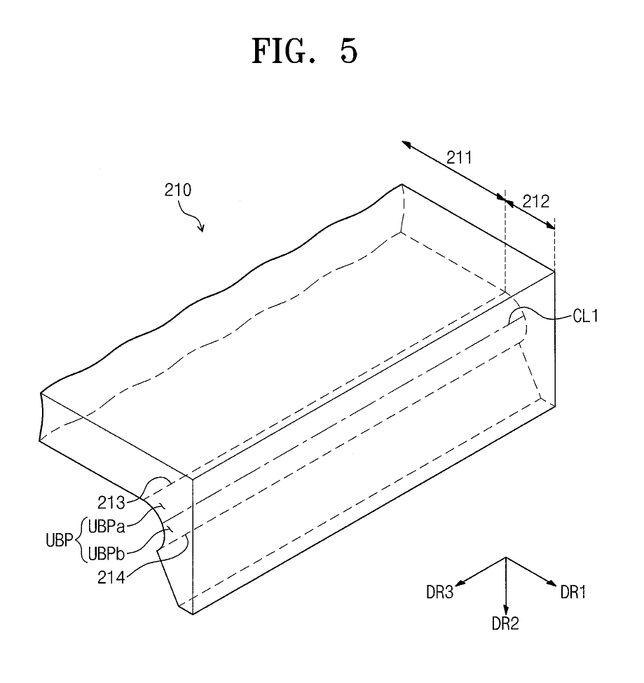

FIG. 5 is a schematic perspective view illustrating a portion of the upper mold of the mold provided in the apparatus for molding the window according to an embodiment of the present disclosure.

Referring to FIG. 5, the upper bending surface UBP of the upper bending part 211 may be divided into a first sub upper bending surface UBPa and a second sub upper bending surface UBPb. In detail, the upper bending surface UBP of the upper bending part 211 may be divided into a first sub upper bending surface UBPa having one end 213 connected to the upper flat part 211 and a second sub upper bending surface UBPb having the other end 214 spaced from the upper flat part 211, based on a central line CL1. At least a portion of the second sub upper bending surface UBPb may overlap at least a portion of the first sub upper bending surface UBPa on the plane. However, an embodiment of the present disclosure is not limited thereto. For example, at least a portion of the second sub upper bending surface UBPb may not overlap the first upper bending surface UBPa on the plane.

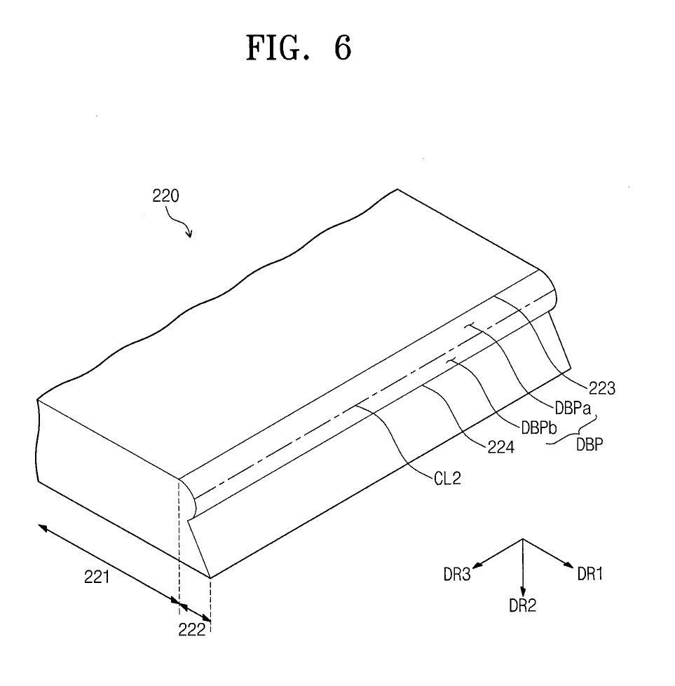

FIG. 6 is a schematic perspective view illustrating a portion of the lower mold of the mold provided in the apparatus for molding the window according to an embodiment of the present disclosure.

Referring to FIG. 6, the lower bending surface DBP of the lower bending part 222 may be divided into a first sub lower bending surface DBPa and a second sub lower bending surface DBPb. In detail, the lower bending surface DBP of the lower bending part 222 may be divided into a first sub lower bending surface DBPa having one end connected to the lower flat part 221 and a second sub lower bending surface DBPb having the other end spaced from the lower flat part 221, based on a central line CL2. At least a portion of the second sub lower bending surface DBPb may overlap at least a portion of the first sub lower bending surface DBPa on the plane. However, an embodiment of the present disclosure is not limited thereto. For example, at least a portion of the second sub lower bending surface DBPb may not overlap the first lower bending surface DBPa on the plane.

The window bending part WBP of the base window BW that is the object to be cooled, which is located between the upper and lower molds 210 and 220, may have the same curvature radius and bending angle as those of each of the upper and lower bending surfaces UBP and DBP.

FIG. 7 is a schematic perspective view of the base window that is the object to be cooled in the cooling device provided in the apparatus for molding the window according to an embodiment of the present disclosure.

Referring to FIG. 7, the base window BW that is the object to be cooled, which is located in the mold MD may include two window bending parts WBP. The window bending part WBP may include a first sub window bending part WBPa connected to one end of the window flatness part WFP and a second sub window bending part WBPb connected to the other end of the window flatness part WFP. For example, the second sub window bending part WBPb and the first sub window bending part WBPa may be spaced from each other in the first direction DR1. The first sub window bending part WBPa, the window flatness part WFP, and the second sub window bending part WBPb are integrally connected to each other.

Although the first and second sub window bending parts WBPa and WBPb have the same bending angle in FIG. 7, the first and second sub window bending parts WBPa and WBPb may have bending angles different from each other as occasion demands.

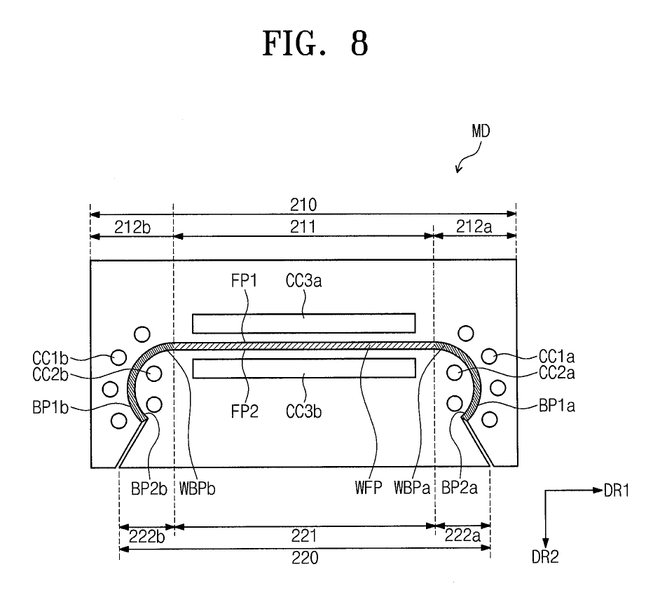

FIG. 8 is a schematic cross-sectional view of the mold provided in the apparatus for molding the window according to an embodiment of the present disclosure.

Referring to FIG. 8, the first bending surface BP1 includes a first sub bending surface BP1a provided on the first sub window bending part WBPa and connected to one end of the window flatness part WFP and a second sub bending surface BP1b provided on the second sub window bending part WBPb and connected to the other end of the window flatness part WFP. The first cooling part CC1 includes a first sub cooling part CC1a for cooling the first sub bending surface BP1a and a second sub cooling part CC1b for cooling the second sub bending surface BP1b. The first sub cooling part CC1a and the second sub cooling part CC1b may cool the first sub cooling part CC1a and the second sub cooling part CC1b by using the cooling source having the first temperature, respectively.

The second bending surface BP2 includes a third sub bending surface BP2a provided on the first sub window bending part WBPa and connected to one end of the window flatness part WFP and a fourth sub bending surface BP2b provided on the second sub window bending part WBPb and connected to the other end of the window flatness part WFP. The second cooling part CC2 includes a third sub cooling part CC2a for cooling the third sub bending surface BP2a and a fourth sub cooling part CC2b for cooling the fourth sub bending surface BP2b. The third sub cooling part CC2a and the second sub cooling part CC2b may cool the first sub cooling part CC1a and the second sub cooling part CC1b by using the cooling source having the second temperature, respectively. As described above, the first temperature is less than the second temperature.

The third cooling part CC3 may include a fifth sub cooling part CC3a for cooling the first flat surface FP1 of the base window BW and a sixth sub cooling part CC3b for cooling the second flat surface FP2 of the base window BW. Although the fifth and sixth sub cooling parts CC3a and CC3b have the same cross-section in FIG. 5, an embodiment of the present disclosure is not limited thereto. Also, a portion of the fifth sub cooling part CC3a may not overlap the sixth sub cooling part CC3b on the plane.

Each of the upper and lower molds 210 and 220 may have a structure corresponding to the two window bending parts WBP. For example, the upper mold 210 may include two upper bending parts 212. In detail, the upper bending part 212 may include a first sub upper bending part 212a connected to one end of the upper flat part 211 and a second sub upper bending part 212b connected to the other end of the upper flat part 211.

The lower mold 220 may include two lower bending parts 222. In detail, the lower bending part 222 may include a first sub lower bending part 222a connected to one end of the lower flat part 221 and a second sub lower bending part 222b connected to the other end of the lower flat part 221.

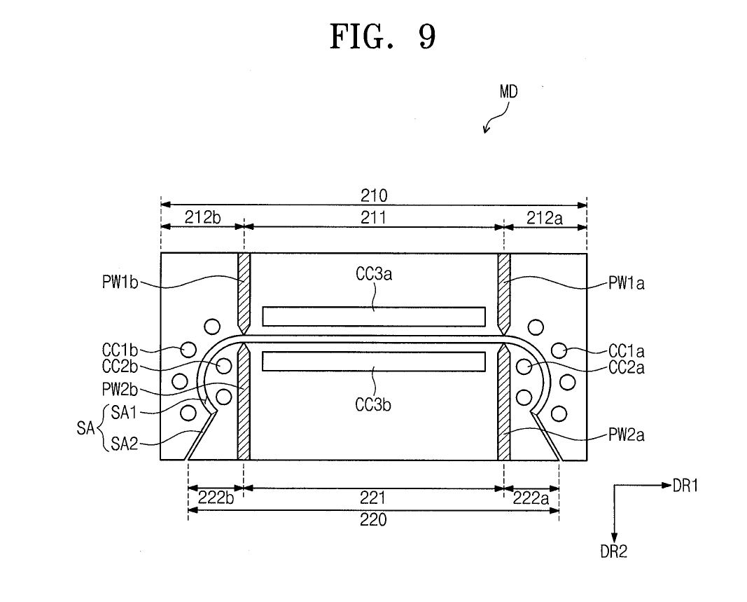

FIG. 9 is a schematic cross-sectional view of the mold provided in the apparatus for molding the window according to an embodiment of the present disclosure.

Referring to FIG. 9, the mold MD may further include first partition walls located in the upper mold 210 and second partition walls located in the lower mold 220. The first partition walls PW1a and PW1b are located between the upper bending parts 212a and 212b and the upper flat part 211. The second partition walls PW2a and PW2b are located between the lower bending parts 222a and 222b and the lower flat part 221. Each of the first partition walls PW1a and PW1b may have thermal conductivity less than that of the upper mold 210, and the second partition walls PW2a and PW2b may have thermal conductivity less than that of the lower mold 220. Each of the first partition walls PW1a and PW1b and the second partition walls PW2a and PW2b may be formed of a material having low thermal conductivity, for example, glass or heat resistant plastic.

However, an embodiment of the present disclosure is not limited thereto. For example, the first partition walls PW1 may not be located between the upper bending parts 212a and 212b and the upper flat parts 211 of the upper mold 210, the upper bending parts 212a and 212b and the upper flat part 211 of the upper mold 210 may be spaced from each other to form an air layer between the upper bending parts 212a and 212b and the upper flat part 211.

Each of the first partition walls PW1a and PW1b may have a cross-section of which a portion has a width that gradually decreases (i.e., tapers) toward a contact surface with the base window BW. The portion having the width that gradually decreases may have one end contacting the contact surface with the base window BW. Each of the first partition walls PW1a and PW1b may have a relatively narrow width at a position closer to the contact surface with the base window BW to prevent unnecessarily suppressing the cooling temperature being transferred to the base window BW.

Each of the second partition walls PW2a and PW2b may have a cross-section of which a portion has a width that gradually decreases toward a contact surface with the base window BW. The portion having the width that gradually decreases may have one end contacting the contact surface with the base window BW. Each of the second partition walls PW2a and PW2b may have a relatively narrow width at a position closer to the contact surface with the base window BW to prevent unnecessarily suppressing the cooling temperature being transferred to the base window BW.

When the upper mold 210 includes two upper bending parts 212, the first partition walls PW1a and PW1b may include a first sub partition wall PW1a located between the upper flat part 211 and the first sub upper bending part. 212a and a second sub partition wall PW1b located between the upper flat part 211 and the second sub upper bending part 212b.

When the lower mold 220 includes two lower bending parts 222, the second partition walls PW2a and PW2b may include a first sub partition wall PW2a located between the lower flat part 221 and the first sub lower bending part 222a and a second sub partition wall PW1b located between the lower flat part 221 and the second sub lower bending part 222b.

The first partition wall located in the upper mold 210 may prevent heat from being transferred between the upper flat part 211 and the upper bending parts 212a and 212b of the upper mold 210. The first partition walls having relatively low thermal conductivity may be located between the upper flat part 211 and the upper bending parts 212a and 212b to prevent the cooling temperatures of the upper flat part 211 and the upper bending parts 212a and 212b from being affected with respect to each other.

The second partition walls located in the lower mold 220 may prevent heat from being transferred between the lower flat part 221 and the lower bending parts 222a and 222b of the lower mold 220. The first partition walls having relatively low thermal conductivity may be located between the lower flat part 221 and the lower bending parts 222a and 222b to prevent the cooling temperatures of the lower flat part 221 and the lower bending parts 222a and 212b from being affected with respect to each other.

As described above, in the apparatus 1000 for molding the window according to an embodiment of the present disclosure, the first bending surface BP1 having the relatively wide area may be controlled to have a cooling temperature less than that of the second bending surface BP2 having the relatively narrow area to prevent the warpage from occurring. The first partition walls and the second partition walls having the relatively low thermal conductivity may be provided to allow more accurate control of the relative temperature relation, thereby maximizing the warpage suppression effect.

The upper mold 210 and the lower mold 220 may be spaced from each other. A space SA between the upper mold 210 and the lower mold 220 may be divided into a base window seating region SA1 in which the base window BW that is the object to be cooled is seated and a peripheral region SA2 connected to the base window seating region SA1.

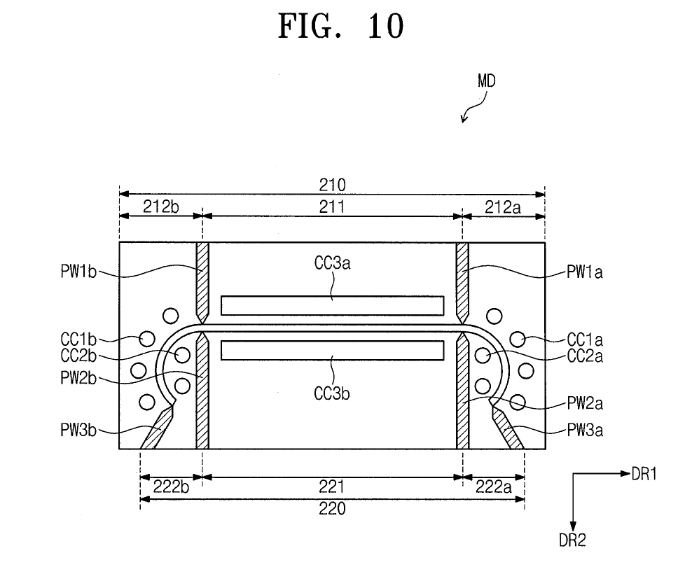

FIG. 10 is a schematic cross-sectional view of the mold provided in the apparatus for molding the window according to an embodiment of the present disclosure.

Referring to FIG. 10, third partition walls PW3a and PW3b having relatively less thermal conductivity when compared to those of the upper and lower molds 210 and 220 may be located in the peripheral region SA2. Since effects due to the third partition walls PW3a and PW3b and a material for forming the third partition walls PW3a and PW3b are the same as each of the first partition walls PW1a and PW1b and the second partition walls PW2a and PW2b, their duplicated descriptions will not be provided.

Although each of the window bending part WBP of the base window BW, the upper bending surface UBP of the upper mold 210, and the lower bending surface DBP of the lower mold 220 are bent with a predetermined curvature radius in FIGS. 2 to 10, an embodiment of the present disclosure is not limited thereto. For example, the window bending part WBP of the base window BW, the upper bending surface UBP of the upper mold 210, and the lower bending surface DBP of the lower mold 220 may have a “ [symbol] ” shape in cross-section.

The base window BW may be molded to the window that is final object via the pulling part 300 and the cutting part 400 after being cooled. The window that is the final object may be located on a display panel of the display device. A touch screen panel may be further located between the display panel and the window. Although not limited thereto, the display panel may be an organic light emitting display panel including an organic light emitting diode.

According to the apparatus 1000 for molding the window according to an embodiment of the present disclosure, the warpage of the window bending part may be minimized during the cooling.

Hereinafter, a method for molding the window according to an embodiment of the present disclosure will be described. Hereinafter, different points with respect to the apparatus 1000 for molding the window according to the foregoing embodiment of the present disclosure will primarily be described, and thus, non-explained portions will be quoted from the apparatus 1000 for molding the window according to the foregoing embodiment of the present disclosure.

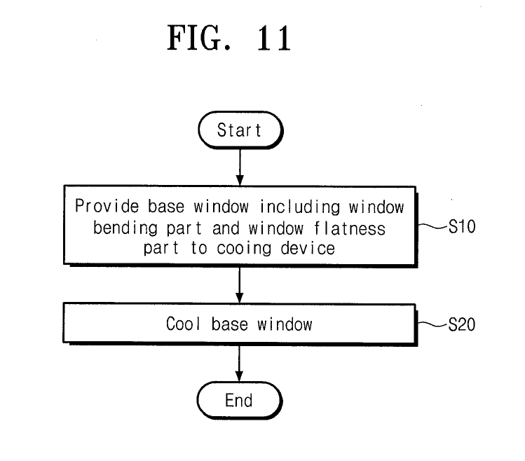

FIG. 11 is a schematic flowchart of a process for molding a window according to an embodiment of the present disclosure.

Referring to FIG. 11, a method for molding a window according to an embodiment of the present disclosure includes a process S10 of providing a base window 500 that is an object to be cooled and a process S20 of cooling the base window 500. The base window 500 includes a window bending part 520 and a window flatness part 510. The window bending part 520 includes a first bending surface 521 and a second bending surface 522, which face each other. The first bending surface 521 has an area greater than that of the second bending surface 522.

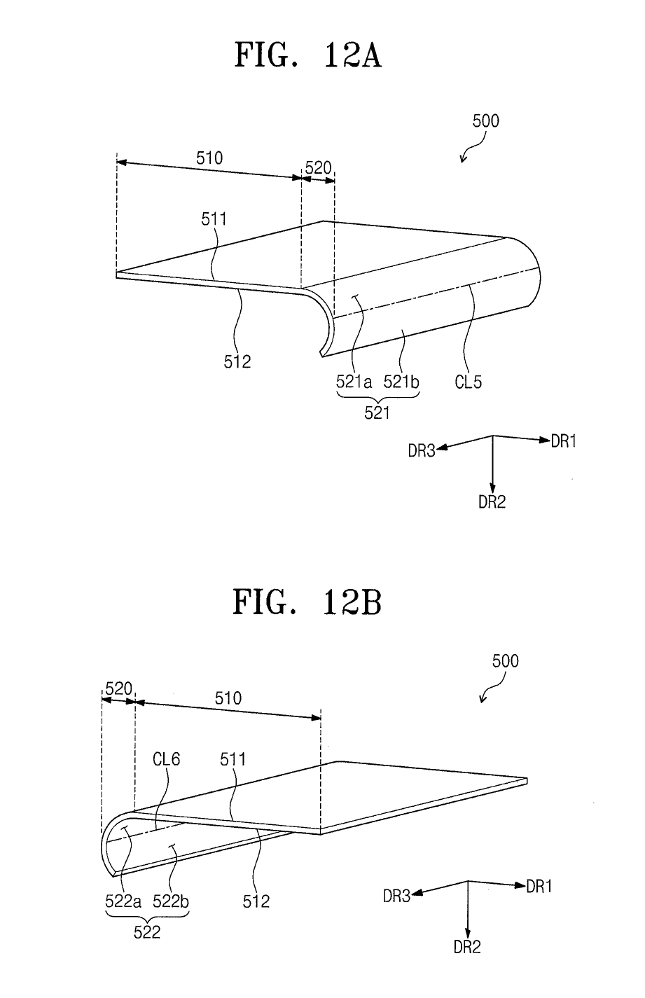

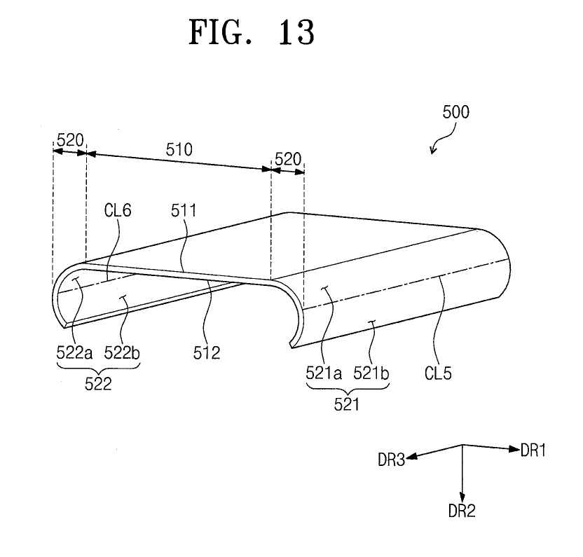

FIGS. 12A, 12B, 13 are schematic perspective views of the base window that is molded by using the method for molding the window according to an embodiment of the present disclosure.

Referring to FIGS. 12A, 12B, and 13, the first bending surface 521 of the base window 500 may be divided into a first sub bending surface 521a having one end connected to the window flatness part 510 and a second sub bending surface 521b having the other end that is spaced from the window flatness part 510, based on a central line CL5. At least a portion of the second sub bending surface 521b may overlap a portion of the first sub bending surface 521a on a plane. The second bending surface 522 of the base window 500 may be divided into a third sub bending surface 522a having one end connected to the window flatness part 510 and a fourth sub bending surface 522b having the other end that is spaced from the window flatness part 510, based on a central line CL6. At least a portion of the fourth sub bending surface 522b may overlap a portion of the third sub bending surface 522a on a plane. Here, the term “on the plane” may denote a case in which the base window 500 is viewed in a thickness direction DR2.

The base window 500 may include one window bending part 520 or a plurality of window bending parts 520. In other words, the number of window being part 520 of the base window 500 may vary as occasion demands.

Since the detailed descriptions of the base window 500 are equally applied to the base window BW that is described in the apparatus 1000 for molding the window according to the foregoing embodiment of the present disclosure, their detailed descriptions will not be provided.

A process S10 of providing the base window 500 to a cooling device may be a process S10 of providing the base window BW including the window bending part WBP and the window flatness part WFP to a cooling device.

Referring to FIGS. 2 and 11, the process of providing the base window 500 to the cooling device may be a process of providing the base window to the cooling device including a mold MD that includes an upper mold 210 and a lower mold 220. For example, the process of providing the base window 500 to the cooling device may be a process of injecting the base window 500 between the upper and lower molds 210 and 220. The upper mold 210 includes an upper bending part 212 contacting the first bending surface 521 and an upper flat part 211 contacting the window flatness part 510, and the lower mold 220 may include a lower bending part 221 contacting the second bending surface 522 and a lower flat part 221 contacting the window flatness part 510. Detailed descriptions of the mold MD are the same as those of the mold MD according to the foregoing embodiment of the present disclosure, and thus, their detailed descriptions will not be provided.

The process of cooling the base window BW includes a process of cooling the first bending surface 521 by using a cooling source having a first temperature, a process of cooling the second bending surface 522 by using a cooling source having a second temperature, and a process of cooling the window flatness part 510 by using a cooling source having a third temperature. The first temperature is less than the second temperature. Since the first bending surface 521 having a relatively wide area is quickly cooled at a temperature less than that of the second bending surface 522 having a relatively low area to suppress an occurrence of warpage.

The process of cooling the first bending surface 521, the process of cooling the second bending surface 522, and the process of cooling the window flatness part 510 are not limited to an order thereof. For example, the above described processes may be performed at the same time.

The process of cooling the first bending surface 521, the process of cooling the second bending surface 522, and the process of cooling the window flatness part 510 may be performed by using a general cooling method that is well known to the person skilled in the art. For example, the process of cooling the first bending surface 521 may be a process of cooling the first bending surface 521 by using a method in which cooling water having a first temperature circulates through the cooling device located around the first bending surface 521.

The process of cooling the window flatness part 510 may be a process of cooling the window flatness part 510 by using a cooling source having a third temperature. In one embodiment, the first temperature, the second temperature, and the third temperature may satisfy the following Equation 1.

First temperature<Third temperature<Second temperature [Equation 1]

The method for molding the window according to an embodiment of the present disclosure may further include a process of extruding a material for the base window 500 before the process S10 of providing the base window 500 to the cooling device and a process of receiving the extruded material to mold the base window 500 including the window flatness part 510 and the window bending part 520.

The method for molding the window according to an embodiment of the present disclosure may further include a process that is well known to the person skilled in the art. For example, the method for molding the window according to an embodiment of the present disclosure may further include a process of pulling the base window 500 that is cooled after the process S20 of cooling the base window 500 and a process of cutting the base window 500 to obtain a window that is a final object.

According to the method for molding the window according to an embodiment of the present disclosure, the relative temperature relation may be controlled to prevent the warpage from occurring in the cooling process. Thus, the warpage occurring when the window base is cooled may be minimized.

In the apparatus for molding the window according to the embodiment of the present disclosure, the warpage of the base window, which occurs during the cooling of the base window in the cooling device may be minimized.

In the method for molding the window according to the embodiment of the present disclosure, the warpage of the bending part of the base window, which occurs during the cooling of the base window may be minimized.

Although the embodiment of the present disclosure is described with reference to the accompanying drawings, those with ordinary skill in the technical field of the present disclosure pertains will be understood that the present disclosure can be carried out in other specific forms without changing the technical idea or essential features. Thus, the above-disclosed embodiments are to be considered illustrative and not restrictive.

The above-disclosed subject matter is to be considered illustrative and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An apparatus for molding a window, the apparatus comprising:
a mold in which a base window comprising a window bending part and a window flatness part is configured to be located, wherein the window bending part comprises a first bending surface and a second bending surface which face each other, and
a cooling device configured to cool the base window located in the mold, the cooling device comprising:
a first cooling part configured to cool the first bending surface by using a cooling source having a first temperature;
a second cooling part configured to cool the second bending surface by using a cooling source having a second temperature; and
a third cooling part configured to cool the window flatness part,
wherein the first bending surface has an area greater than an area of the second bending surface, and
wherein the first temperature is less than the second temperature.

2. The apparatus of claim 1, wherein the first bending surface has a first curvature radius, and
wherein the second bending surface has a second curvature radius less than the first curvature radius.

3. The apparatus of claim 1, wherein the third cooling part is configured to cool the window flatness part by using a cooling source having a third temperature, and
wherein the third temperature is greater than the first temperature and less than the second temperature.

4. The apparatus of claim 1, wherein the mold comprises:
an upper mold comprising an upper bending part configured to contact the first bending surface and an upper flat part contacting the window flatness part; and
a lower mold comprising a lower bending part configured to contact the second bending surface and a lower flat part contacting the window flatness part.

5. The apparatus of claim 1, wherein the first bending surface comprises a first sub bending surface connected to one end of the window flatness part and a second sub bending surface connected to the other end of the window flatness part, and wherein the second bending surface comprises a third sub bending surface connected to one end of the window flatness part and a fourth sub bending surface connected to the other end of the window flatness part,
wherein the first cooling part comprises:
a first sub cooling part configured to cool the first sub bending surface; and
a second sub cooling part configured to cool the second sub bending surface,
wherein the second cooling part comprises:
a third sub cooling part configured to cool the third sub bending surface; and
a fourth sub cooling part configured to cool the fourth sub bending surface.

6. The apparatus of claim 1, wherein the window flatness part comprises a first flat surface and a second flat surface which face each other, and
wherein the third cooling part comprises:
a fifth sub cooling part configured to cool the first flat surface; and
a sixth sub cooling part configured to cool the second flat surface.

7. The apparatus of claim 4, wherein the first cooling part is located in the upper bending part of the upper mold,
wherein the second cooling part is located in the lower bending part of the lower mold, and
wherein the third cooling part is located in at least one of the upper flat part of the upper mold and the lower flat part of the lower mold.

8. The apparatus of claim 4, wherein the upper bending part comprises an upper bending surface configured to contact the first bending surface,
wherein the lower bending part comprises a lower bending surface configured to contact the second bending surface, and
wherein the upper bending surface has an area greater than that of the lower bending surface.

9. The apparatus of claim 8, wherein the upper bending surface has a third curvature radius, and
the lower bending surface has a fourth curvature radius less than the third curvature radius.

10. The apparatus of claim 8, wherein, based on a central line, the upper bending surface is divided into a first sub upper bending surface comprising one end connected to the upper flat part and a second sub upper bending surface comprising the other end spaced from the upper flat part, and
wherein at least a portion of the second sub upper bending surface overlaps at least a portion of the first sub upper bending surface on a plane.

11. The apparatus of claim 8, wherein, based on a central line, the lower bending surface is divided into a first sub lower bending surface comprising one end connected to the lower flat part and a second sub lower bending surface comprising the other end spaced from the lower flat part, and
wherein at least a portion of the second sub lower bending surface overlaps at least a portion of the first sub lower bending surface on a plane.

12. The apparatus of claim 4, further comprising:
a first partition wall located between the upper bending part and the upper flat part; and
a second partition wall located between the lower bending part and the lower flat part,
wherein the first partition wall has thermal conductivity less than that of the upper mold, and
wherein the second partition wall has thermal conductivity less than that of the lower mold.

13. The apparatus of claim 4, wherein the upper mold and the lower mold are spaced from each other, and
wherein a space between the upper mold and the lower mold is divided into a base window seating region and a peripheral region connected to the base window seating region.

14. The apparatus of claim 13, further comprising a third partition wall located in the peripheral region,
wherein the third partition wall has thermal conductivity less than that of each of the upper mold and the lower mold.

15. The apparatus of claim 1, further comprising a provision part configured to provide the base window,
wherein the provision part comprises:
an extruder configured to receive and extrude a material for the base window; and
a die configured to receive the extruded the material, thereby discharging the received material of the base window comprising the window flatness part and the window bending part.

16. A method for molding a window, the method comprising:
providing a base window comprising a window bending part and a window flatness part to a cooling device, wherein the window bending part comprises a first bending surface and a second bending surface which face each other, wherein the first bending surface has an area greater than that of the second bending surface, and
cooling the base window, the cooling of the base window comprising:
cooling the first bending surface using a cooling source having a first temperature;
cooling the second bending surface using a cooling source having a second temperature, wherein the first temperature is less than the second temperature; and
cooling the window flatness part.

17. The method of claim 16, wherein the cooling of the window flatness part comprises cooling the window flatness part using a third temperature, and
wherein the first temperature, the second temperature, and the third temperature satisfy a following Equation 1:
First temperature<Third temperature<Second temperature [Equation 1]

18. The method of claim 16, wherein the providing of the base window to the cooling device comprises providing the base window to the cooling device comprising an upper mold and a lower mold,
wherein the upper mold comprises an upper bending part contacting the first bending surface and an upper flat part contacting the window flatness part, and
a lower mold comprises a lower bending part contacting the second bending surface and a lower flat part contacting the window flatness part.

19. The method of claim 16, wherein, based on a central line, the first bending surface is divided into a first sub bending surface comprising one end connected to the window flatness part and a second sub bending surface comprising the other end spaced from window flatness part,
wherein at least a portion of the second sub bending surface overlaps at least a portion of the first sub bending surface on a plane, and
wherein based on a central line, the second bending surface is divided into a third sub bending surface comprising one end connected to the window flatness part and a fourth sub bending surface comprising the other end spaced from the window flatness part,
wherein at least a portion of the fourth sub bending surface overlaps at least a portion of the third sub bending surface on a plane.

20. The method of claim 16, before the providing of the base window to the cooling device, further comprising:
extruding a material for the base window; and
molding the extruded material to mold the base window comprising the window flatness part and the window bending part.
